(19) United States
(12) Patent Application Publication
(10) Pub. No.: US 2007/0093958 A1
(43) Pub. Date: Apr. 26, 2007

(54) Method and system for generation of real-time guiding information

(76) Inventors: Bjorn Jonsson, Saltsjobaden (SE); Marcus Nyberg, Hauersten (SE); Mikael Goldstein, Stockholm (SE); Didier Chincholle, Sollentuna (SE); Johan Hjelm, Stockholm (SE)

Correspondence Address: ERICSSON INC., 6300 LEGACY DRIVE, M/S EVR 1-C-11, PLANO, TX, 75024, US

(21) Appl. No.: 10/556,655

(22) PCT Filed: May 12, 2003
(86) PCT No.: PCT/SE04/00768

§ 371 Date: Nov. 12, 2005

(51) Int. Cl. G01C 21/00

(52) U.S. Cl. 701/211; 701/200; 340/995.2

(57) ABSTRACT

A system and method is disclosed for generating information for use, for example, in a vehicle for guidance of driver. Information is described by information object specifications determined in part from compiled data related to the vehicle and its immediate environment, navigation area, target area, and user profile. An analysis and control part (320, 340) of the system creates information objects, optionally assigns priority to the same, and assigns a medium for presentation of an information object. A system state may be determined related to current use of available media. An information object of high priority can cause the control part to reallocate a medium to allow presentation of the high priority information object. The system may further determine need for format transcoding to allow presentation of information on the most appropriate medium.

### BACKGROUND OF THE INVENTION

### TECHNICAL FIELD

This invention relates generally to navigation systems and, in particular, to a method and system for presenting guiding information to a user comprising audile and visual information.

### BACKGROUND

Invent of position systems like GPS (Global Positioning System) is the foundation for navigation systems, e.g. in vehicles. These systems usually comprise displaying a map of suitable scale indicating the current position of the vehicle. In addition, advice can be provided relating to road selection e.g. at road crossings and highway exits. The advice can be provided in text or as audio messages. Map data and informative messages are usually stored on a local storage medium, e.g. a compact disc. A position determining system, e.g. a GPS receiver, generates position data that is input to a control system for selection and presentation of display images and informative messages. A characteristic of these systems is that they are static in the sense that display images and messages are independent of user context. The dynamic properties of known systems are usually limited to a dependence on the position of the vehicle. Furthermore, the type of images displayed in known systems is the same, independent of user context and usually directed towards assisting a driver in route selection.

There is, thus, a need for an improved navigation system that overcomes deficiencies of known systems and adds further functionality.

### RELATED ART

An improved navigation system is disclosed in U.S. Pat. No. 6,182,010 by Viktors Berstis. According to Berstis a visual image, e.g. a photograph, of the location is retrieved and displayed when the vehicle approaches a given location. This allows a driver to more accurately assess the position e.g. relative to an intersection where an action may be needed. Further, according to Berstis, the dynamic characteristics of the system are improved in that there is a set of visual images, e.g. photographs, relating to different times of day and/or different times of the year. Berstis also discloses downloading the display data from a server improving the dynamic characteristics of changing environmental data. The system of Berstis is directed towards assisting a driver in the selection of route and does not mention any other type of guidance. The Berstis system is, further, independent of other contextual data than vehicle position and time of day or year.

The European Patent Application EP 1069406 and German Patent DE 19738764 disclose a system for guiding a driver comprising the display of graphical information representative of topographical characteristics forehead of the driver. For example, a graphical curve section indicates direction and radius of curvature of an upcoming curve in the road. The type of guiding information aims to support a safe drive. The displayed images are representative of objects and/or topographical characteristics forehead of the driver and may change display position, form, or color in dependence of vehicle position and speed of vehicle.

### SUMMARY OF THE INVENTION

It is a general object to provide an improved method and system for efficiently providing guiding information to a person performing a particular primary task such as driving a car.

It is also an object of the invention to present guiding information using presentation medium such as to cause as little distraction as possible from a primary task. In this respect it is particularly desirable to be able take the degree of importance of a new guiding information message into account in the overall process of presenting guiding information.

Another object of the invention is to create guiding information in dependence of a consideration of input information received from a plurality of information sources.

These and other objects are met by the invention as defined by the accompanying patent claims.

In a first aspect of the invention, a basic idea is to generate information for guiding or informing a driver of a vehicle whereby input information is processed from a plurality of input information sources. For each received information data, a corresponding data category is determined, and at least partly in dependence on the category of data, a specification of at least one presentation information object is generated. At least one medium for presentation is determined for each considered presentation information object. Information associated with the presentation information object(s) is then retrieved at least in accordance with the specification and preferably also the medium or media, and finally the information is output for presentation.

In different aspects of the invention, the input information can relate to the vehicle and its immediate neighborhood, a geographical area that is calculated to be traversed from the current vehicle position to a specified target, information characteristic of the target, and/or user specified requirements or preferences. More specifically, a vehicle information object can be characterized by properties relating to vehicle condition as indicated by various sensors, vehicle velocity, environmental conditions including road near characteristics. A calculated area to be traversed can be described as a navigation information object characterized as comprising road sections with certain properties, various services, and various points of interest. A target information object can be described in terms of object structures, e.g. a city comprises a street infrastructure and provides services such as hotel services that can be further described in terms of room availability and quality, price, reception opening hours and so forth. A user information object can comprise information relating to a preferred route passing certain places, quality and price of hotel that conveniently correspond to a preferred time for overnight. It is desirable, when possible considering the primary task, to present information according to user preferences for example relating to points of interest.

It is has further turned out to be particularly advantageous to provide a rule-based engine for managing input information received from a plurality of input information sources.

According to a preferred embodiment the type or category of input is determined for the input data. Exemplary types or categories include position data, vehicle condition data such as temperature and fuel, weather forecast, traffic data, user specified data such as historical data about visited places. Input data and corresponding data category are processed to determine a specification of a message and corresponding information is retrieved from specified storage locations if not included as part of the input data. For example, depending on the condition of the vehicle the driver may need to find a service station. The system can determine from user preference information the preferred type of service station and calculate from position data a suitable route whereby map data is retrieved from a map information source.

Preferably, a user can receive guiding information through several media, e.g. one or several audio and video channels.

Advantageously, the guiding system can select or transform information for presentation in a format that is most convenient for the user. It is highly desirable to provide means for transcoding an original guiding information message into a format suitable for presentation on the most appropriate medium considering the effect of distraction from the primary task. For example, text information can be transcoded into audio information. Another type of format conversion comprises transcoding visual information from one visual format to another visual format. For example, at high speed the driver would prefer not to be distracted by irrelevant information and unnecessary details related to objects in the neighborhood could be deleted and, in some instances, object abstractions may convey the necessary information for a safe and correct driving.

It has been recognized that specific demands on the driver, e.g. a need for high focus on road conditions when driving at a high speed or at difficult driving conditions related to weather or traffic conditions make certain guiding information more important than other information.

Therefore, in a second aspect of the invention, a priority level for information from at least one of the information sources is determined. The information in question may be presentable through several media. Next, a medium for presentation of the information is selected at least partly in dependence on the priority level, and finally the information is presented through the selected medium.

In this respect, it is highly desirable to provide means for managing media such that a more important message can interrupt or disrupt an occupied medium for immediate presentation of information of higher importance.

It has turned out to be particularly beneficial to first determine for which medium that the presentation information object is primarily intended. If this medium is currently occupied, it is determined in dependence on said priority level whether said information should be overlaid on the medium, or the ongoing presentation should be interrupted for allowing presentation of the new presentation information or another one of the media should be used for presentation.

In another aspect of the invention the guiding information also depends on target characteristics. For example, a targeted hotel or camping area may be unmanned and closed for new visitors after a certain time of the day. Such information is valuable to the driver when planning the route. A particular case comprises a moving target whereby guiding information is presented to the driver of each vehicle aiming to find a suitable meeting place. In this case the guiding information presented to each driver may depend on, besides the position of each driver, other characteristics of a calculated meeting place. For example, a meeting place on a highway would apparently not be possible for several reasons.

It is desirable that a user in advance of commencing the travel can prepare certain data. These data may be stored locally at the vehicle or at a network node for downloading. The data may relate to the position of the vehicle or to vehicle condition. Exemplary, when there is a need to fill up fuel a petrol station of preference may be located. Some of these data may be more static stored in a static user profile whereas other data may relate to a specific occasion and stored in a dynamic user profile.

The in advance prepared data is preferably retrieved at certain events for processing. For example an event, representing a type of input data recorded by input data means, may comprise reaching a predefined position. Data associated with this event typically relate to hot spots in the neighborhood of the event triggering position. Event associated data is retrieved from specified locations, e.g. identified by a URL address.

Advantageously a user can edit the user profile at any time during the travel and, for example, modify a desire to find the fastest route disregarding any costs for road tolls.

The invention offers the following advantages:
guiding information is determined on basis of data from a plurality of relevant information sources,
guiding information is presented on the medium that is most appropriate from the point of view of safety and other priority factors,
priority is assigned to guiding information messages allowing high priority messages to override low priority messages,
guiding information can be transcoded from a format to another,
guiding information can be prepared by user in advance of travel for use at the occurrence of a trigger event.

Other advantages offered by the present invention will be appreciated upon reading of the below description of the embodiments of the invention.

### BRIEF DESCRIPTION OF THE DRAWINGS

For a more complete understanding of the invention and its advantages the following detailed description should be taken in conjunction with the accompanying drawings of which:

FIG. 1 is an exemplary data object model related to the invention;

FIG. 2 illustrates an exemplary structure of a type of information object;

FIG. 3 is a simplified illustration of an arrangement according to an exemplary embodiment of the invention; and

FIG. 4 shows the steps in a method according to an exemplary embodiment of the invention.

### DETAILED DESCRIPTION OF PREFERRED EMBODIMENTS

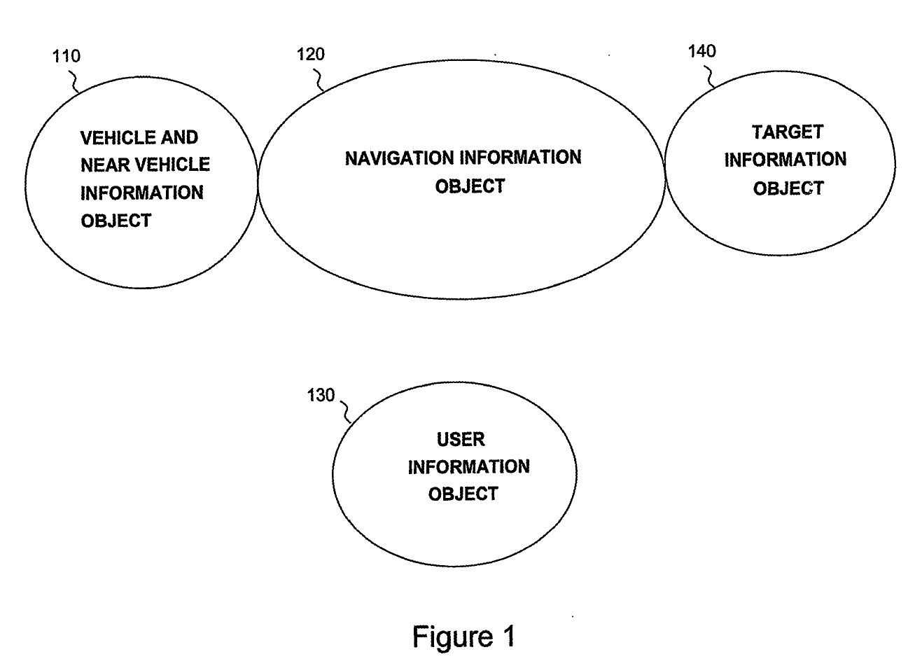

FIG. 1 shows a data object model related to the invention. At 110 a vehicle information object is illustrated that relates to the vehicle and its immediate environment. Data relating to this object may be obtained from sensors associated with the vehicle measuring e.g. speed, fuel, temperature of cooling water, and outside temperature. Environmental data pertaining to, e.g., the weather or the traffic situation may be obtained from broadcast transmission, e.g., through a digital broadcast system such as the RDS system (Radio Data System) preferably over the TMC channel (Traffic Message Channel). For more information on TMC, reference is made to the following World Wide Web link http://www.tmcforum.com/tmc/what_is.htm, printed Apr. 8, 2003.

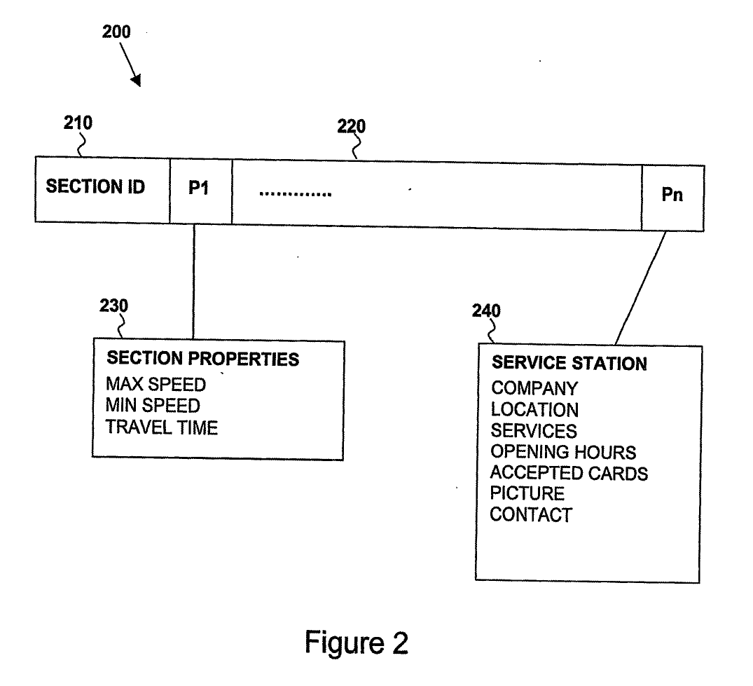

At 120 a navigation information object is illustrated relating to the navigation area, i.e. the area that is expected to include the path between the current vehicle position and the current target position. These data may include a geographical map area determined by the system from knowledge of vehicle and target positions. Other data that may be included in the data object 120 relate to objects and places within a geographical area. In particular, a road section object according to the invention has properties relating to, e.g., position on map, road characteristics, speed limitations, road tolls, and availability of services. An exemplary data representation of a road section object is shown in FIG. 2 comprising a data record 200. A first data part 210 comprises a section identity. This identity can, e.g., be used to address data storage for retrieving data for visualization of the section on a map. The data record 220 further comprises property references P1-Pn. These references address data records, e.g. data records 230 and 240. Exemplary, data record 230 may include information about speed limitations and a normal time to travel the section. Data record 240 may pertain to a service station whereby a user can obtain information about its location, opening hours, available services, and credit cards that are accepted.

At 130 a user information object is illustrated. This object may comprise user specifications e.g. relating to characteristics of the desired route. Besides dynamic data pertaining to a specific occasion, time period, or journey, the user profile also comprises more static data. Static data can e.g. identify sensors at the vehicle for various measurements, addresses to remote locations for download of specified information, and events that should occur when a specified parameter value reaches a specified limit value. For example, if the fuel level decreases below a preset value, guiding information may appear for locating a fuel station of preferred mark. Dynamic data may refer to places that should be visited during the travel and references to information sources that can provide information about a visited place. Other dynamic data may relate to hotels that are planned for overnights.

At 140 there is illustrated a target information object. This object can include position of a target and other data in dependence of specifications in the user profile 130 or requirements derived therefrom by the system. For example, if the target object is a hotel and the user profile specifies a desire to check-in at that hotel, the system retrieves hotel check-in times and derives a planned time of arrival. If the navigation system determines that time of arrival will not be before reception closes if the planned route is followed, the system proposes a changed route if possible and, otherwise, locates a closer hotel of similar standard. It is thus understood that a target can change during travel depending on changing circumstances or desires. An initial target can comprise an identified city. When approaching the city a user can redefine target according to what city objects that are available. For example, there can be selectable city tours in turn comprising objects such as famous buildings and museums. From a previous example, relating to a user receiving an alarm that service of the vehicle is needed, it is further clear that the navigation system can temporarily change a target. Thus, e.g., when fuel has been filled up after stop at a fuel station, the system resets the target to the original.

In a particular case, the target is another vehicle and a common objective for the two parties is to find a suitable meeting place. The navigation managers of the two vehicles constantly update routes to take. The navigation manager also determines that a suitable meeting place must allow both vehicles to stop and the two parties to physically meet. Thus, e.g., the meeting place should preferably not be located along a highway. Further conditions on a meeting place can be agreed by the two parties, e.g. that a meeting place should be close to or at a restaurant. The navigation manager of the respective vehicle calculates a route for each vehicle based on these and other data pertaining to the navigation area and user specifications whereby the analysis can use road section characteristics.

Generally, the information or data objects 110-140 can contain further data objects. For example, data object 120 may contain road object further comprising road section objects. Data pertaining to the data objects are of a variety of data types such as graphical images, photographic images, text, audio, and video. A particular data object can have several representations, e.g. a photographic image and an object abstraction in the form of a graphical image. In some cases a transcoder converts an object representation from one type of medium to another type, e.g. from text to audio.

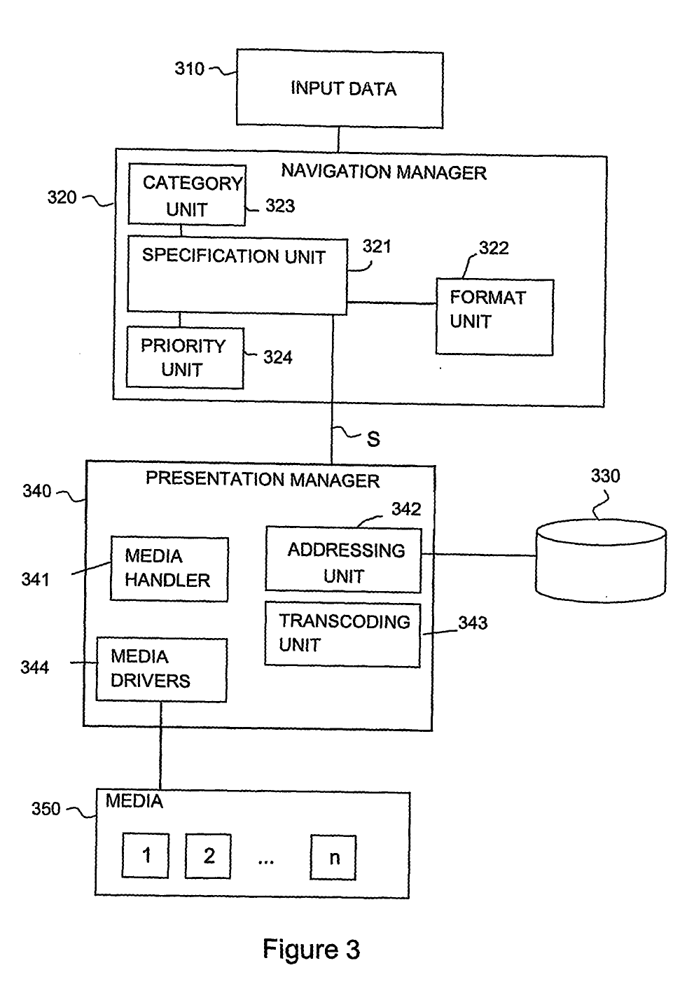

FIG. 3 shows a simplified illustration of a system according to an exemplary embodiment of the invention. The system includes means 310 for compiling input data for example received from sensor means at the vehicle, storage means 330 including user profile and data relating to objects. The storage means 330 generally comprises a local part and a remote part for downloading of data for example over a wireless connection. At 320 there is shown a navigation manager. The navigation manager has a specification unit 321 for operating on the input data to generate a specification of guiding information. For example, from knowledge of vehicle and target positions, provided in input data 310, the navigation manager determines a specification of map information illustrating a possible route to follow or the navigation manager detects deviation of received input data from predetermined level causing it to generate a message description. The navigation manager 320 further includes format unit 322 for determining a preferred information format, e.g. voice. There is also a data category unit 323 for determining a category of the input data information. Category of data information may relate to alarm data received from vehicle sensors, broadcast information received e.g. from an RPS-system or the occurrence of an event e.g. the reaching of a predefined position.

Prior to forming a message specification at specification unit 321, a message priority may be determined at priority unit 324. The priority unit 324 analyses a received input file and normally determines a message priority at least partly in dependence of input information category. The message priority is preferably included in the output specification S from the specification unit 321.

At 340 there is illustrated a presentation manager for forming presentation data according to a specification of guiding information. The specification, in addition, preferably includes information for retrieval of specified information. Included in the presentation manager 340 there is an addressing unit 342 for accessing specified data from local or remote sources, e.g. database 330. The presentation manager 340 further has a media handler 341 for allocation of medium or media appropriate for a presentation according to the format specification.

The media handler 341 typically manages media and allocation of media to messages for presentation. The media handler 341 can further determine a system state. A system state can specify messages being processed and allocated to a medium, messages having been interrupted or deleted or queued for later presentation.

The presentation manager 340 further has a transcoding unit 343 for transcoding information that resides at database 330 originally stored in a format not conforming to the specified preferred format. For example, if input data indicates that the driver of a vehicle is likely not benefited from a very detailed map the navigation manager includes, in the format specification, directives to replace certain objects with abstractions thereof, e.g. obtained from a symbol database 330.

The media handler 341 in consideration of system status and priorities of incoming messages determines actions, e.g. that a new message shall be overlaid on an already occupied medium, or that an ongoing presentation shall be temporarily interrupted for presentation of the new message, or that a free medium shall be allocated to the new message. The media handler can also determine that a new message shall be transcoded into a format different from the original format specified in the specification S output from specification unit 321. For example, if the preferred format of a new message is determined to be voice, the priority is determined to be low, and the voice medium is occupied with a higher priority task, then the media handler can initiate transcoding of the new message into a text message.

A media file is output, preferably from media handler 341, comprising various media parts further managed by corresponding media drivers included in driver unit 344. Each driver in the driver unit 344 drives a corresponding one of the available media, 1-n, 350.

Visual map information is conveniently prepared by presentation manager 340 and oriented such that the vehicle velocity vector is normally directed upwards on a displayed map. This arrangement facilitates the identification of objects in the surrounding of the vehicle e.g. located to the left, right, or in front of the vehicle.

It should be understood that FIG. 3 provides a functional overview of an exemplary system, and that other specific implementations may be equally feasible.

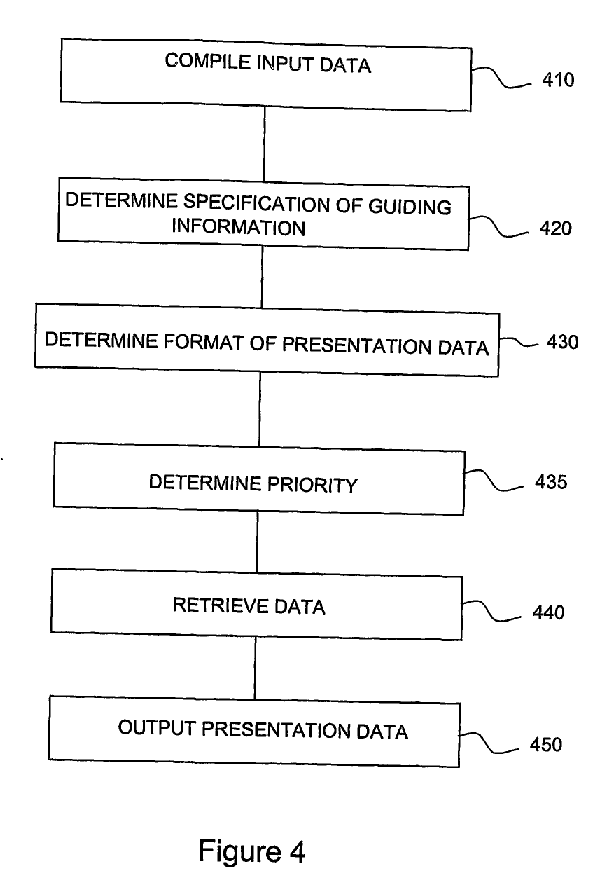

FIG. 4 shows a flow chart illustrating the steps of a method according to a preferred embodiment of the invention. At step 410 input data is compiled from various sources for determining guiding information. At step 420 additional data typically is determined from rules operating on the input data. The rules are normally software implemented at the navigation manager. For modifications of the rules a user can manipulate at least part of a rules database. At step 430 the format of presentation data is determined. This step too preferably depends on the evaluation of rules operating on input parameters. For example, if speed of vehicle exceeds a certain limiting value rules evaluate for determining suitable presentation formats, e.g. excluding detailed graphical information for display. In the optional, but often advantageous, step 435 the priority of new information is compared with priority of ongoing presentation and appropriate actions are invoked. In step 440 presentation data is generated that conforms to the determined presentation formats. This step may include transcoding of certain data that cannot directly be retrieved in the most appropriate format. Certain data, stored in several formats, is retrieved according to the determined and preferred format. At step 450 the calculated guiding information is presented on a specified medium.

It is understood that the foregoing description shall be taken by way of example only not limiting the scope of the invention and that a person skilled in the art therefrom shall be able to derive a variety of further implementations of the invention.

1. A system for producing guiding information for a user in a vehicle, comprising:
means for receiving information from a plurality of information sources;
means for presenting information through a plurality of media
means for processing information from the plurality of said information sources to create a specification of a message comprising at least one information object,
means for determining preferred medium for presentation of said message in a first format, and for determining an alternative medium for presentation of said message in a second format;
means for retrieving information associated with said at least one information object, and
means for output of information associated with said at least one information object for presentation on a selected one of said preferred medium and said alternative medium.

2. The system of claim 1, wherein said means for output comprises
means for transcoding said message into said second format for presentation on said alternative medium, wherein said second format is different from the original first format specified in the message specification.

3. The system of claim 1, wherein said means for output comprises
means for replacing at least one information object by a stored abstraction of the object from a symbol database.

4. The system of claim 1, wherein said information is related to at least one of a vehicle information object, a navigation information object, a user information object and a target information object.

5. The system of claim 4, wherein the navigation information object includes road section objects having at least one of length, service points, road tolls and points of interest.

6. The system of claim 4, wherein the target information object includes a representation of another moving vehicle and said at least one presentation information object includes a representation of an instantaneous route to a meeting place at least fulfilling predetermined characteristics.

7. The system according to claim 1 further comprising:
means for determining a system state, and
means for enforcement of rules applied to the specification of at least one information object and the system state, the rules further being operative to change the system state.

8. The system of claim 7, wherein:
the system state includes allocation of available media to information objects,
said change of system state involving a reallocation of at least one medium.

9. The system of claim 7, wherein said means for enforcement of rules generates a request for transcoding of said at least one information object.

10. A method for producing guiding information for a user in a vehicle capable of receiving information from a plurality of information sources and presenting information through a plurality of media, comprising the steps of:
processing information from a plurality of said information sources to create a specification of a message comprising at least one information object,
determining preferred medium for presentation of said message in a first format and an alternative medium for presentation of said message in a second format;
retrieving information associated with said at least one information object, and
presenting information associated with said at least one information object on a selected one of said preferred medium and said alternative medium.

11. The method of claim 10, further comprising transcoding said message into said second format for presentation on said alternative medium, wherein said second format is different from the original first format specified in the message specification.

12. The method of claim 10, further comprising replacing at least one information object by a stored abstraction of the object from a symbol database.

13. The method of claim 10, wherein said information is related to at least one of a vehicle information object, a navigation information object, a user information object and a target information object.

14. The method of claim 13, wherein the navigation information object includes road section objects having at least one of length, service points, road tolls, and points of interest.

15. The method of claim 13, wherein the target information object includes a representation of another moving vehicle and said at least one information object includes a representation of an instantaneous route to a meeting place at least fulfilling predetermined characteristics.

16. The method according to claim 13, wherein target information in said target information object is changeable in dependence of information in at least one of said vehicle information object, said navigation information object and said user information object.

17. The method according to claim 10, further comprising the steps of:
determining a system state, and
enforcement of rules applied to the specification of at least one information object and the system state, the rules further being operative to change the system state.

18. The method of claim 17, wherein:
the system state includes allocation of available media to information objects, and
said change of system state involves reallocation of medium.
